(19) United States
(12) Patent Application Publication
(10) Pub. No.: US 2017/0092004 A1
(43) Pub. Date: Mar. 30, 2017

(54) HEAD-MOUNTED DISPLAY DEVICE, CONTROL METHOD FOR HEAD-MOUNTED DISPLAY DEVICE, AND COMPUTER PROGRAM

(71) Applicant: SEIKO EPSON CORPORATION, Tokyo (JP)

(72) Inventors: Kazuo NISHIZAWA, Matsumoto-shi (JP); Yuichi MORI, Minowa-machi (JP)

(73) Assignee: SEIKO EPSON CORPORATION, Tokyo (JP)

(21) Appl. No.: 15/261,618

(22) Filed: Sep. 9, 2016

(30) Foreign Application Priority Data
Sep. 29, 2015 (JP) 2015-190545

(51) Int. Cl. G06T 19/00; G02B 27/01; G06K 9/00; H04N 13/04; G06T 7/00

(52) U.S. Cl. CPC G06T 19/006; H04N 13/044; G06T 7/004; H04N 13/0422; G06K 9/00375; G02B 27/017; H04N 2013/0081

(57) ABSTRACT

A head-mounted display device (an HMD) includes a display section. The HMD includes a target-object-depth-information acquiring section configured to acquire target-object depth information indicating depth from the HMD concerning a target object visually recognized via the display section, an operation-body-depth-information acquiring section configured to acquire operation-body depth information indicating depth from the HMD concerning an operation body operated by a user in an outside world around the HMD, and an auxiliary-image-display control section configured to cause, when determining on the basis of the acquired target-object depth information and the acquired operation-body depth information that a positional relation between the target object and the operation body satisfies a predetermined condition in a depth direction from the HMD, the display section to display an auxiliary image for facilitating recognition of a position in the depth direction concerning the target object.

### BACKGROUND

1. Technical Field

The present invention relates to a head-mounted display device, a control method for the head-mounted display device, and a computer program.

2. Related Art

There has been known a head-mounted display device that is worn on the head of a user and used to thereby present augmented reality (AR) information in a visual field region of the user (e.g., JP-A-2015-84150 (Patent Literature 1)). The AR is a technique for superimposing, on a real space, a virtual object generated by a computer and performing display. The user wearing the head-mounted display device can experience the augmented reality by visually recognizing, in the visual field region, both of a target object present in the real space and the virtual object, which is the AR information.

In the related art, the user needs to visually recognize, in the visual field region, both of the target object present in the real space and the AR information. Therefore, it is not easy to grasp in which position the target object is present in the depth direction of the real space.

Note that this problem is not limited to the target object in the real space and is common to the case in which it is grasped in which position a target object (a 3D object) disposed in a virtual three-dimensional space is present in the depth direction. Besides, in the head-mounted display device in the past, improvement of convenience of a user, improvement of detection accuracy, compactness of a device configuration, a reduction in costs, resource saving, facilitation of manufacturing, and the like have been demanded.

### SUMMARY

An advantage of some aspects of the invention is to solve at least a part of the problems, and the invention can be implemented as the following aspects.

(1) An aspect of the invention is directed to a head-mounted display device including a display section. The head-mounted display device includes: a target-object-depth-information acquiring section configured to acquire target-object depth information indicating depth from the head-mounted display device concerning a target object visually recognized via the display section; an operation-body-depth-information acquiring section configured to acquire operation-body depth information indicating depth from the head-mounted display device concerning an operation body operated by a user in an outside world around the head-mounted display device; and an auxiliary-image-display control section configured to cause, when determining on the basis of the acquired target-object depth information and the acquired operation-body depth information that a positional relation between the target object and the operation body satisfies a predetermined condition in a depth direction from the head-mounted display device, the display section to display an auxiliary image for facilitating recognition of a position in the depth direction concerning the target object. With the head-mounted display according to this aspect, when it is determined that the positional relation between the target object and the operation body satisfies the predetermined condition in the depth direction from the head-mounted display device, the auxiliary image for facilitating the recognition of the position in the depth direction concerning the target object is displayed on the display section. Therefore, the user can easily grasp in which position the target object is present in the depth direction.

(2) In the head-mounted display device according to the aspect, the auxiliary-image-display control section may cause the display section to display the auxiliary image when determining that the operation body has moved further to the target object side than a first position located on the head-mounted display device side by a first distance from the target object in the depth direction. With the head-mounted display device according to this aspect, it is possible to display the auxiliary image when the operation body has moved further to the target object side than the first position. Therefore, the user can cause the display section to display the auxiliary image only when the operation body has moved further to the target object side than the first position. The auxiliary image is not displayed when the operation body is present further on the head-mounted display device side than the first position. Therefore, since the auxiliary image is not displayed when the operation body has not approached the target object, the head-mounted display device is excellent in convenience for the user.

(3) In the head-mounted display device according to the aspect, the head-mounted display device may include a two-dimensional-position-information acquiring section configured to acquire two-dimensional-position information indicating a position of the target object and a position of the operation body in a two-dimensional space perpendicular to the depth direction. The auxiliary-image-display control section may stop the display of the auxiliary image when determining that the operation body has moved further to the target object side than a second position located on the head-mounted display device side by a second distance shorter than the first distance from the target object in the depth direction and determined that a distance between the operation body and the target object in the two-dimensional space is a distance smaller than a predetermined value on the basis of the acquired two-dimensional-position information. With the head-mounted display device according to this aspect, the display of the auxiliary image is stopped when it can be determined that the operation body has sufficiently approached the target object in the two-dimensional space in addition to the depth direction. Accordingly, immediately before work is performed on the target object by the operation body, the display of the auxiliary image is erased. Therefore, the auxiliary image does not hinder the work. It is possible to prevent workability from being deteriorated.

(4) In the head-mounted display device according to the aspect, the auxiliary image may be a line group formed by lining up, at a fixed interval, rectangular broken lines formed by collections of dots having the same depth. With the head-mounted display device in this aspect, it is possible to further facilitate the recognition of the position in the depth direction concerning the target object.

(5) In the head-mounted display device according to the aspect, the display section may be a display section through which the outside world can be visually recognized, and the operation body may be an object actually present in the outside world. With the head-mounted display device according to this aspect, it is possible to further facilitate the recognition of the position in the depth direction concerning the target object actually present in the outside world.

(6) In the head-mounted display device according to the aspect, the operation body may be an object disposed in a virtual three-dimensional space, and the target-object depth information may be information indicating depth to the target object in the virtual three-dimensional space. With the head-mounted display device according to this aspect, it is possible to further facilitate the recognition of the position in the depth direction concerning the target object disposed in the virtual three-dimensional space.

Not all of the plurality of constituent elements of the aspect of the invention explained above are essential. To solve a part or all of the problems or to achieve a part or all of the effects described in this specification, concerning a part of the plurality of constituent elements, it is possible to appropriately perform a change, deletion, replacement with new other constituent elements, and partial deletion of limited contents. To solve a part or all of the problems or to achieve a part or all of the effects described in this specification, it is also possible to combine a part or all of the technical features included in one aspect of the invention explained above with a part or all of the technical features included in the other aspects of the invention explained above to obtain one independent aspect of the invention.

The invention can also be implemented in various forms other than the head-mounted display device. The invention can be implemented as, for example, a control method for the head-mounted display device, a computer program for implementing functions of components included in the head-mounted display device, and a recording medium having the computer program recorded therein.

### BRIEF DESCRIPTION OF THE DRAWINGS

The invention will be described with reference to the accompanying drawings, wherein like numbers reference like elements.

FIG. 1 is an explanatory diagram showing the schematic configuration of a head-mounted display device in an embodiment of the invention.

FIG. 2 is a block diagram functionally showing the configuration of the HMD.

FIG. 3 is an explanatory diagram showing an example of augmented reality display by the HMD.

FIG. 4 is an explanatory diagram showing an example of a form of use of the HMD.

FIG. 5 is a flowchart for explaining an auxiliary-image display routine.

FIG. 6 is an explanatory diagram showing an example of a depth map.

FIG. 7 is an explanatory diagram showing an example of a marker.

FIG. 8 is a plan view of the HMD and a first ball viewed from above.

FIG. 9 is an explanatory diagram showing an example of an auxiliary image.

FIG. 10 is a flowchart for explaining an auxiliary-image-display stop routine.

FIG. 11 is an explanatory diagram illustrating a visual field of a user immediately before display of the auxiliary image is stopped.

FIG. 12 is an explanatory diagram illustrating the visual field of the user immediately after the display of the auxiliary image is stopped.

FIG. 13 is an explanatory diagram illustrating the visual field of the user in a state in which the display of the auxiliary image is not stopped.

FIG. 14 is an explanatory diagram showing a shadow functioning as the auxiliary image in a modification 1.

FIGS. 15A and 15B are explanatory diagrams showing the configurations of the exteriors of HMDs in modifications.

### DESCRIPTION OF EXEMPLARY EMBODIMENTS

### A. Basic Configuration of a Head-Mounted Display Device

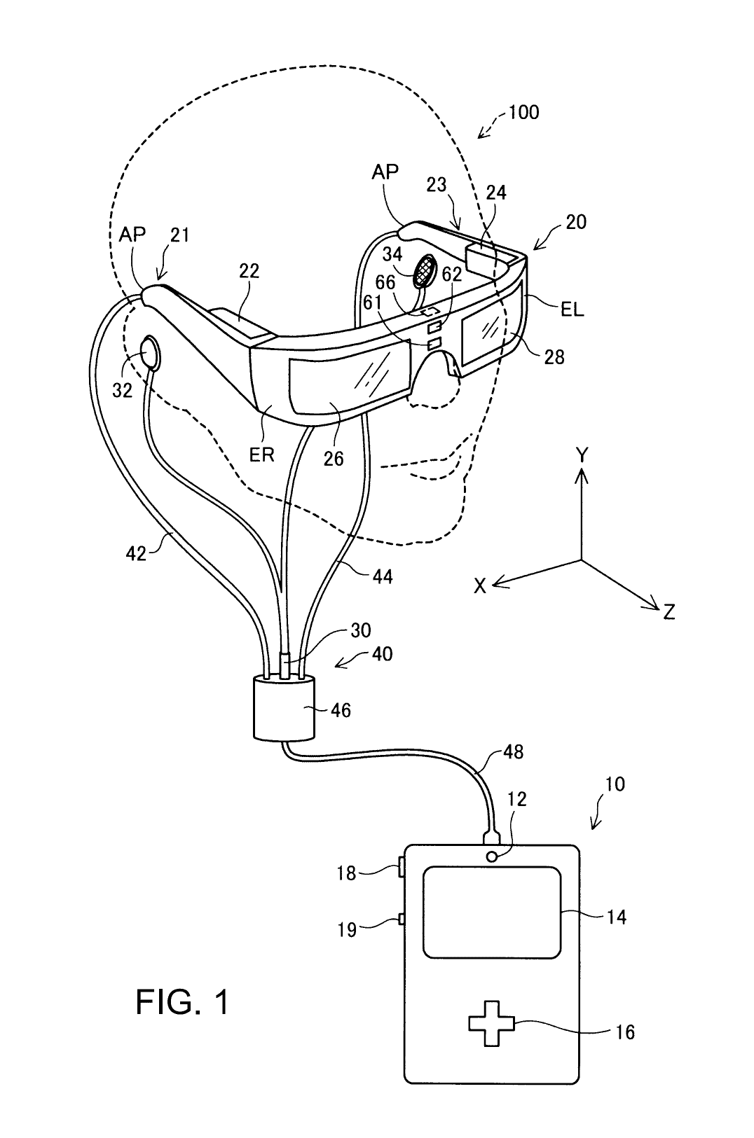

FIG. 1 is an explanatory diagram showing the schematic configuration of a head-mounted display device in an embodiment of the invention. A head-mounted display device 100 is a display device mounted on a head and is also called head mounted display (HMD). The HMD 100 is a head-mounted display device of a see-through type in which an image emerges in an outside world visually recognized through glass.

The HMD 100 includes an image display section 20 that causes a user to visually recognize a virtual image in a state in which the image display section 20 is worn on the head of the user and a control section (a controller) 10 that controls the image display section 20.

The image display section 20 is a wearing body worn on the head of the user. In this embodiment, the image display section 20 has an eyeglass shape. The image display section 20 includes a right holding section 21, a right display driving section 22, a left holding section 23, a left display driving section 24, a right optical-image display section 26, and a left optical-image display section 28. The right optical-image display section 26 and the left optical-image display section 28 are disposed to be respectively located in front of the right eye and in front of the left eye of the user when the user wears the image display section 20. One end of the right optical-image display section 26 and one end of the left optical-image display section 28 are connected to each other in a position corresponding to the middle of the forehead of the user when the user wears the image display section 20.

The right holding section 21 is a member provided to extend from an end portion ER, which is the other end of the right optical-image display section 26, to a position corresponding to the temporal region of the user when the user wears the image display section 20. Similarly, the left holding section 23 is a member provided to extend from an end portion EL, which is the other end of the left optical-image display section 28, to a position corresponding to the temporal region of the user when the user wears the image display section 20. The right holding section 21 and the left holding section 23 hold the image display section 20 on the head of the user like temples of eyeglasses.

The right display driving section 22 is disposed on the inner side of the right holding section 21, in other words, a side opposed to the head of the user when the user wears the image display section 20. The left display driving section 24 is disposed on the inner side of the left holding section 23. Note that, in the following explanation, the right holding section 21 and the left holding section 23 are explained as “holding sections” without being distinguished. Similarly, the right display driving section 22 and the left display driving section 24 are explained as “display driving sections” without being distinguished. The right optical-image display section 26 and the left optical-image display section 28 are explained as “optical-image display sections” without being distinguished.

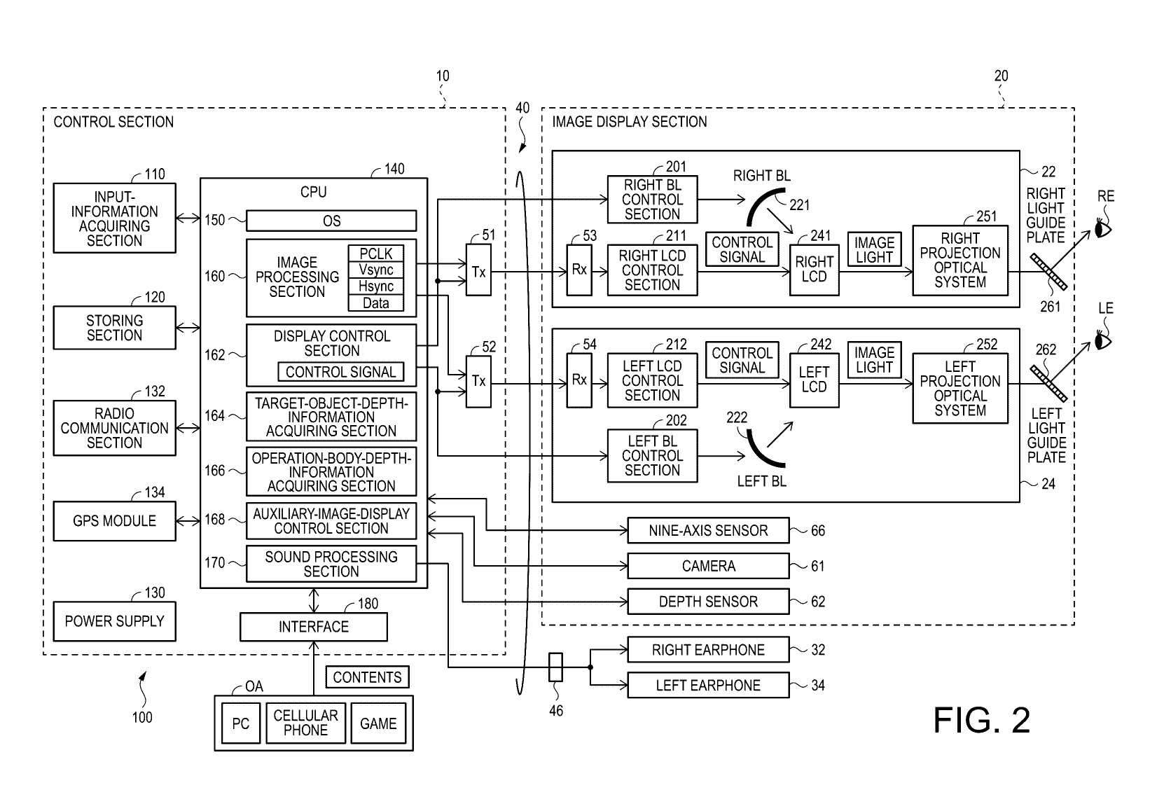

The display driving sections 22 and 24 include liquid crystal displays (hereinafter referred to as “LCDs”) 241 and 242 and projection optical systems 251 and 252 (see FIG. 2). Details of the configuration of the display driving sections are explained below. The optical-image display sections functioning as optical members include light guide plates 261 and 262 (see FIG. 2) and dimming plates. The light guide plates 261 and 262 are formed of a light transmissive resin material or the like and guide image lights output from the display driving sections 22 and 24 to the eyes of the user. The dimming plates are thin plate-like optical elements and are arranged to cover the front side (a side opposite to the side of the eyes of the user) of the image display section 20. The dimming plates protect the light guide plates 261 and 262 and suppress damage, adhesion of soil, and the like to the light guide plates 261 and 262. By adjusting the light transmittance of the dimming plates, it is possible to adjust an external light amount entering the eyes of the user and adjust easiness of visual recognition of the virtual image. Note that the dimming plates can be omitted.

The image display section 20 further includes a connecting section 40 for connecting the image display section 20 to the control section 10. The connecting section 40 includes a main body cord 48 connected to the control section 10, a right cord 42 and a left cord 44, which are two cords branching from the main body cord 48, and a coupling member 46 provided at a branch point. The right cord 42 is inserted into a housing of the right holding section 21 from a distal end portion AP in an extending direction of the right holding section 21 and connected to the right display driving section 22. Similarly, the left cord 44 is inserted into a housing of the left holding section 23 from a distal end portion AP in an extending direction of the left holding section 23 and connected to the left display driving section 24. A jack for connecting an earphone plug 30 is provided in the coupling member 46. A right earphone 32 and a left earphone 34 extend from the earphone plug 30.

The image display section 20 and the control section 10 perform transmission of various signals via the connecting section 40. Connectors (not shown in the figure), which fit with each other, are respectively provided at an end of the main body cord 48 on the opposite side of the coupling member 46 and in the control section 10. The control section 10 and the image display section 20 are connected and disconnected according to fitting and unfitting of the connector of the main body cord 48 and the connector of the control section 10. For example, a metal cable or an optical fiber can be adopted as the right cord 42, the left cord 44, and the main body cord 48.

The control section 10 is a device for controlling the HMD 100. The control section 10 includes a lighting section 12, a touch pad 14, a cross key 16, and a power switch 18. The lighting section 12 notifies, with a light emission state thereof, an operation state of the HMD 100 (e.g., ON/OFF of a power supply). As the lighting section 12, for example, an LED (Light Emitting Diode) is used. The touch pad 14 detects touch operation on an operation surface of the touch pad 14 and outputs a signal corresponding to detected content. As the touch pad 14, touch pads of various types such as an electrostatic type, a pressure detection type, and an optical type can be adopted. The cross key 16 detects pressing operation on keys corresponding to the upward, downward, left, and right directions and outputs a signal corresponding to detection content. The power switch 18 detects slide operation of the switch to switch a state of the power supply of the HMD 100.

FIG. 2 is a block diagram functionally showing the configuration of the HMD 100. The control section 10 includes an input-information acquiring section 110, a storing section 120, a power supply 130, a radio communication section 132, a GPS module 134, a CPU 140, an interface 180, and a transmitting sections (Txs) 51 and 52. The sections are connected to one another by a not-shown bus.

The input-information acquiring section 110 acquires, for example, signals corresponding to operation inputs to the touch pad 14, the cross key 16, the power switch 18, and the like. The storing section 120 is configured by a ROM, a RAM, a DRAM, a hard disk, or the like.

The power supply 130 supplies electric power to the sections of the HMD 100. As the power supply 130, for example, a secondary battery such as a lithium polymer battery or a lithium ion battery can be used. Further, instead of the secondary battery, a primary battery or a fuel battery may be used. Alternatively, the sections may receive wireless power supply and operate. The sections may receive power supply from a solar cell and a capacitor. The radio communication section 132 performs radio communication with other apparatuses according to a predetermined radio communication standard such as a wireless LAN, Bluetooth (registered trademark), or iBeacon (registered trademark). The GPS module 134 receives a signal from a GPS satellite to thereby detect the present position of the GPS module 134.

The CPU 140 reads out and executes computer programs stored in the storing section 120 to thereby function as an operating system (OS) 150, an image processing section 160, a display control section 162, a target-object-depth-information acquiring section 164, an operation-body-depth-information acquiring section 166, an auxiliary-image-display control section 168, and a sound processing section 170.

The image processing section 160 generates a signal on the basis of contents (videos) input via the interface 180 and the radio communication section 132. The image processing section 160 supplies the generated signal to the image display section 20 via the connection cord 40 to control the image display section 20. The signal to be supplied to the image display section 20 is different in an analog format and a digital format. In the case of the analog format, the image processing section 160 generates and transmits a clock signal PCLK, a vertical synchronization signal VSync, a horizontal synchronization signal HSync, and image data Data. Specifically, the image processing section 160 acquires an image signal included in contents. For example, in the case of a moving image, in general, the acquired image signal is an analog signal configured from thirty frame images per one second. The image processing section 160 separates synchronization signals such as the vertical synchronization signal VSync and the horizontal synchronization signal HSync from the acquired image signal and generates the clock signal PCLK with a PLL circuit or the like according to cycles of the synchronization signals. The image processing section 160 converts the analog image signal, from which the synchronization signals are separated, into a digital image signal using an A/D conversion circuit or the like. The image processing section 160 stores the digital image signal after the conversion in the DRAM in the storing section 120 frame by frame as the image data Data of RGB data.

On the other hand, in the case of the digital format, the image processing section 160 generates and transmits the clock signal PCLK and the image data Data. Specifically, when the contents are the digital format, the clock signal PCLK is output in synchronization with the image signal. Therefore, the generation of the vertical synchronization signal VSync and the horizontal synchronization signal HSync and the A/D conversion of the analog image signal are unnecessary. Note that the image processing section 160 may execute, on the image data Data stored in the storing section 120, image processing such as resolution conversion processing, various kinds of tone correction processing such as adjustment of luminance and chroma, and keystone correction processing.

The image processing section 160 transmits the generated clock signal PCLK, the generated vertical synchronization signal VSync, and the generated horizontal synchronization signal HSync and the image data Data stored in the DRAM in the storing section 120 respectively via the transmitting sections 51 and 52. Note that the image data Data transmitted via the transmitting section 51 is referred to as “image data for right eye Data1” as well. The image data Data transmitted via the transmitting section 52 is referred to as “image data for left eye Data2” as well. The transmitting sections 51 and 52 function as a transceiver for serial transmission between the control section 10 and the image display section 20.

The display control section 162 generates control signals for controlling the right display driving section 22 and the left display driving section 24. Specifically, the display control section 162 individually controls, with the control signals, driving ON/OFF of a right LCD 241 by a right LCD control section 211, driving ON/OFF of a right backlight 221 by a right backlight control section 201, driving ON/OFF of a left LCD 242 by a left LCD control section 212, driving ON/OFF of a left backlight 222 by a left backlight control section 202, and the like to thereby control generation and emission of image lights respectively by the right display driving section 22 and the left display driving section 24. The display control section 162 transmits the control signals for the right LCD control section 211 and the left LCD control section 212 respectively via the transmitting sections 51 and 52. Similarly, the display control section 162 transmits the control signals respectively to the right backlight control section 201 and the left backlight control section 202.

The target-object-depth-information acquiring section 164 acquires target-object depth information indicating depth from the HMD 100 concerning a target object in an outside world visually recognized through the HMD 100. The “depth” is a distance from the HMD 100 in a predetermined direction of the HMD 100, that is, a direction that the user faces in a state in which the user wears the image display section 20 on the head. The “depth direction” is a direction that the user faces in the state in which the user wears the image display section 20 on the head, that is, the direction of the optical-image display sections 26 and 28 and is a Z-axis direction in FIG. 1.

The operation-body-information acquiring section 166 acquires hand depth information indicating depth from the HMD 100 concerning a hand of the user that intrudes into the outside world visually recognized through the HMD 100. The hand of the user is equivalent to a subordinate concept of the “operation body” in the aspect of the invention.

The auxiliary-image-display control section 168 causes, when determining on the basis of the target-object depth information acquired by the target-object-depth-information acquiring section 164 and the operation-body depth information acquired by the operation-body-depth-information acquiring section 166 that a positional relation between the target object and the operation body satisfies a predetermined condition in a depth direction from the HMD 100, the display control section 162 to display an auxiliary image for facilitating recognition of a position in the depth direction concerning the target object. The target-object-depth-information acquiring section 164, the operation-body-depth-information acquiring section 166, and the auxiliary-image-display control section 168 are explained in detail below.

The sound processing section 170 acquires a sound signal included in contents, amplifies the acquired sound signal, and supplies the sound signal to a not-shown speaker in the right earphone 32 and a not-shown speaker in the left earphone 34 connected to the coupling member 46. Note that, for example, when a Dolby (registered trademark) system is adopted, processing for the sound signal is performed. Different kinds of sound with varied frequencies or the like are respectively output from the right earphone 32 and the left earphone 34.

The interface 180 is an interface for connecting various external apparatuses OA, which are supply sources of contents, to the control section 10. Examples of the external apparatuses OA include a personal computer PC, a cellular phone terminal, and a game terminal. As the interface 180, for example, a USB interface, a micro USB interface, and an interface for a memory card can be used.

The image display section 20 includes the right display driving section 22, the left display driving section 24, a right light guide plate 261 functioning as the right optical-image display section 26, a left light guide plate 262 functioning as the left optical-image display section 28, a camera 61 (see FIG. 1 as well), a depth sensor 62, and a nine-axis sensor 66.

The camera 61 is an RGB camera and is disposed in a position corresponding to the root of the nose of the user at the time when the user wears the image display section 20. Therefore, the camera 61 picks up a color image of an outside world in a direction that the user faces in a state in which the user wears the image display section 20 on the head. Note that the camera 61 can be a monochrome camera instead of the RGB camera.

The depth sensor 62 is a kind of a distance sensor and is disposed side by side with the camera 61. Therefore, the depth sensor 62 detects depth, which is a distance, from the HMD 100 in a direction that the user faces.

The nine-axis sensor 66 is a motion sensor that detects acceleration (three axes), angular velocity (three axes), and terrestrial magnetism (three axes). In this embodiment, the nine-axis sensor 66 is disposed in a position corresponding to the middle of the forehead of the user. The nine-axis sensor 66 is provided in the image display section 20. Therefore, when the image display section 20 is worn on the head of the user, the nine-axis sensor 66 can detect a movement of the head of the user. The direction of the image display section 20, that is, a visual field of the user is specified from the detected movement of the head.

The right display driving section 22 includes a receiving section (Rx) 53, the right backlight (BL) control section 201 and the right backlight (BL) 221 functioning as a light source, the right LCD control section 211 and the right LCD 241 functioning as a display element, and a right projection optical system 251. Note that the right backlight control section 201, the right LCD control section 211, the right backlight 221, and the right LCD 241 are collectively referred to as “image-light generating section” as well.

The receiving section 53 functions as a receiver for serial transmission between the control section 10 and the image display section 20. The right backlight control section 201 drives the right backlight 221 on the basis of an input control signal. The right backlight 221 is, for example, a light emitting body such as an LED or an electroluminescence (EL) element. The right LCD control section 211 drives the right LCD 241 on the basis of the clock signal PCLK, the vertical synchronization signal VSync, the horizontal synchronization signal HSync, and the image data for right eye Data1 input via the receiving section 53. The right LCD 241 is a transmissive liquid crystal panel on which a plurality of pixels are arranged in a matrix shape. The right LCD 241 changes, by driving liquid crystal in pixel positions arranged in the matrix shape, the transmittance of light transmitted through the right LCD 241 to thereby modulate illumination light radiated from the right backlight 221 into effective image light representing an image.

The right projection optical system 251 is configured by a collimate lens that changes the image light emitted from the right LCD 241 to light beams in a parallel state. The right light guide plate 261 functioning as the right optical-image display section 26 guides the image light output from the right projection optical system 251 to the right eye RE of the user while reflecting the image light along a predetermined optical path. For the optical-image display section, any system can be used as long as the optical-image display section forms a virtual image in front of the eyes of the user using the image light. For example, a diffraction grating may be used or a semitransparent reflection film may be used. Note that the HMD 100 emitting the image light is also referred to as “display an image” as well in this specification.

The left display driving section 24 includes a configuration same as the configuration of the right display driving section 22. That is, the left display driving section 24 includes a receiving section (Rx) 54, the left backlight (BL) control section 202 and the left backlight (BL) 222 functioning as a light source, the left LCD control section 212 and the left LCD 242 functioning as a display element, and a left projection optical system 252. Like the right LCD 241, the left LCD 242 changes, by driving liquid crystal in pixel positions arranged in the matrix shape, the transmittance of light transmitted through the left LCD 242 to thereby modulate illumination light radiated from the left backlight 222 into effective image light representing an image. Note that, although a backlight system is adopted in this embodiment, the image light may be emitted using a front light system or a reflection system.

### B. Augmented Reality Display

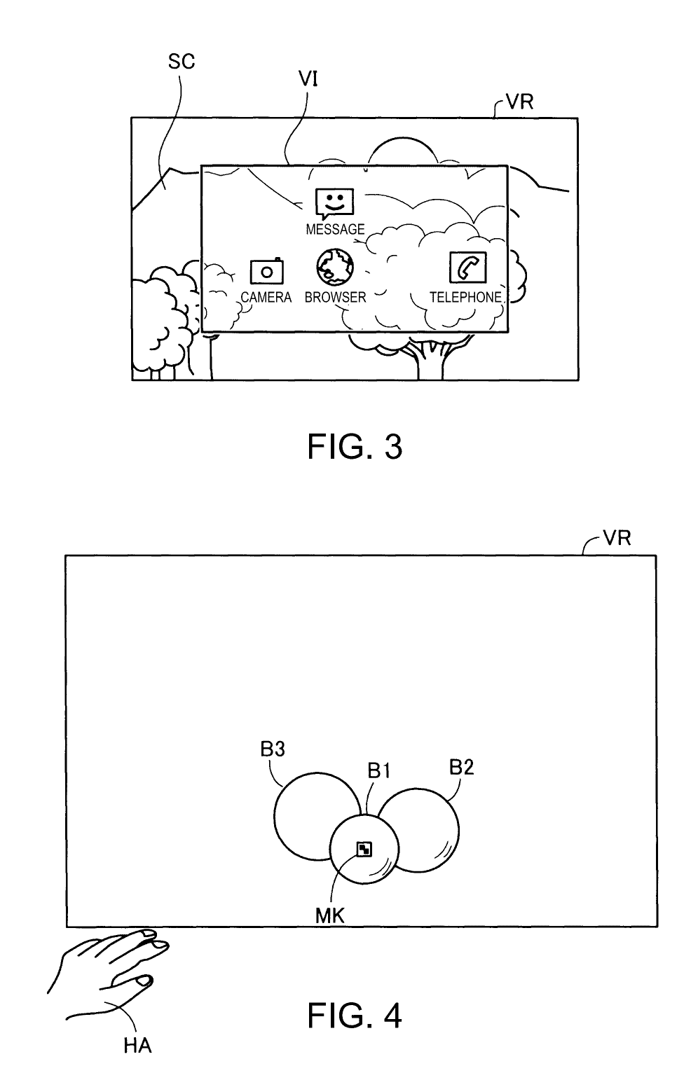

FIG. 3 is an explanatory diagram showing an example of augmented reality display by the HMD 100. In FIG. 3, a visual field VR of the user is illustrated. The image lights guided to both the eyes of the user of the HMD 100 are focused on the retinas of the user, whereby the user visually recognizes an image VI serving as augmented reality (AR). In the example shown in FIG. 3, the image VI is a standby screen of the OS of the HMD 100. The optical-image display sections 26 and 28 transmit light from an outside world SC, whereby the user visually recognizes the outside world SC. In this way, the user of the HMD 100 in this embodiment can view the image VI and the outside scene SC behind the image VI concerning a portion where the image VI is displayed in the visual field VR. The user can view only the outside world SC concerning a portion where the image VI is not displayed in the visual field VR.

FIG. 4 is an explanatory diagram showing an example of a form of use of the HMD 100. In FIG. 4, the visual field VR of the user is illustrated. In the example shown in FIG. 4, the optical-image display sections 26 and 28 transmit light from the outside world SC, whereby the user visually recognizes first to third three balls B1, B2, and B3 present in the outside world. In the example shown in the figure, in a real space, the first ball B1 is located further on the user side, that is, the HMD 100 side than the second ball B2 and the third ball B3. The user visually recognizes the balls located in this way through the optical-image display sections 26 and 28. A marker MK indicating that the first ball B1 is a target object on which work is performed is stuck to the first ball B1 in advance. Although not shown in the figure, AR information is displayed in the vicinity of the marker MK according to necessity. AR information is, for example, work content, a work procedure, and the like.

The user performs work for gripping the first ball B1 with a hand HA of the user while looking at the optical-image display sections 26 and 28. When the gripping work is performed, an auxiliary image for assisting visual recognition of the user is displayed by the auxiliary-image-display control section 168. The target-object-depth-information acquiring section 164, the operation-body-depth-information acquiring section 166, and the auxiliary-image-display control section 168 are functionally implemented by the CPU 140 executing a predetermined program stored in the storing section 120. Details of the predetermined program are explained below.

### C. Auxiliary-Image Display/Display Stop Routines

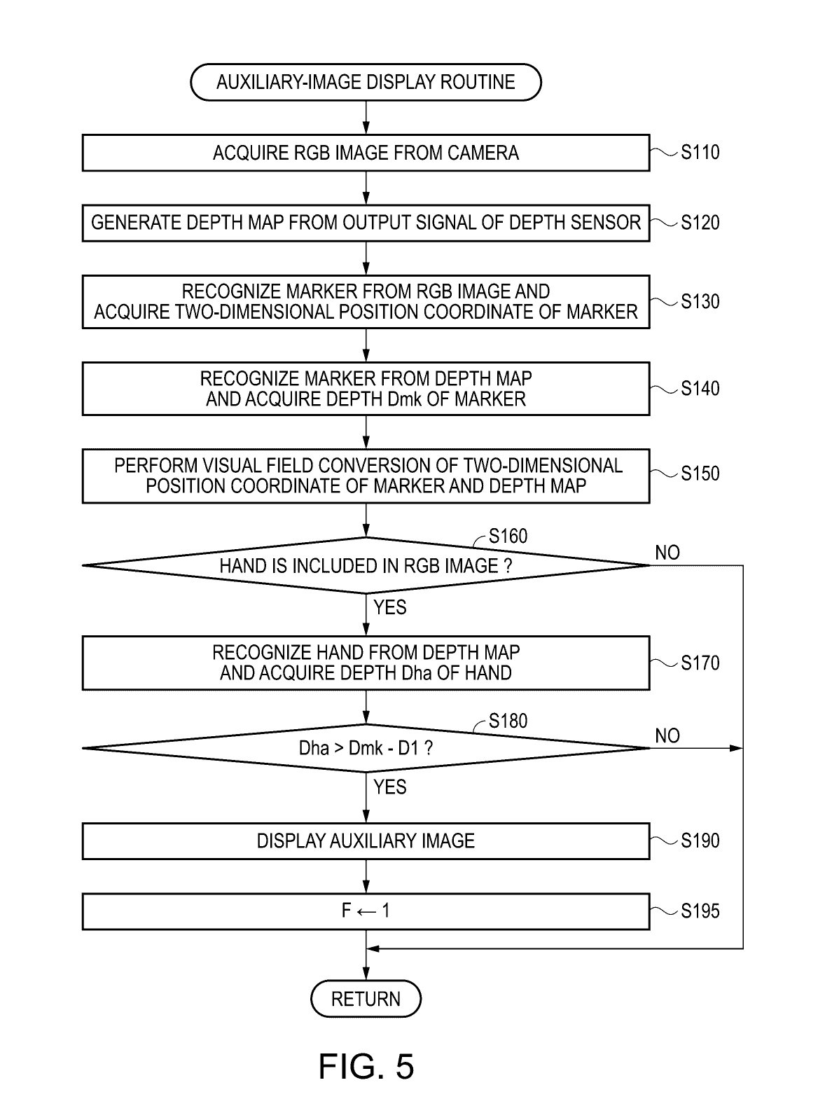

FIG. 5 is a flowchart for explaining an auxiliary-image display routine. The auxiliary-image display routine corresponds to the predetermined program and is repeatedly executed by the CPU 140 at every predetermined time. When processing is started, first, the CPU 140 acquires an RGB image from the camera 61 (step S110), grasps an outside world as a two-dimensional image from an output signal of the depth sensor 62, and generates a depth map (a distance image) that indicates depth in pixels of the image with light and shade of the pixels (step S120).

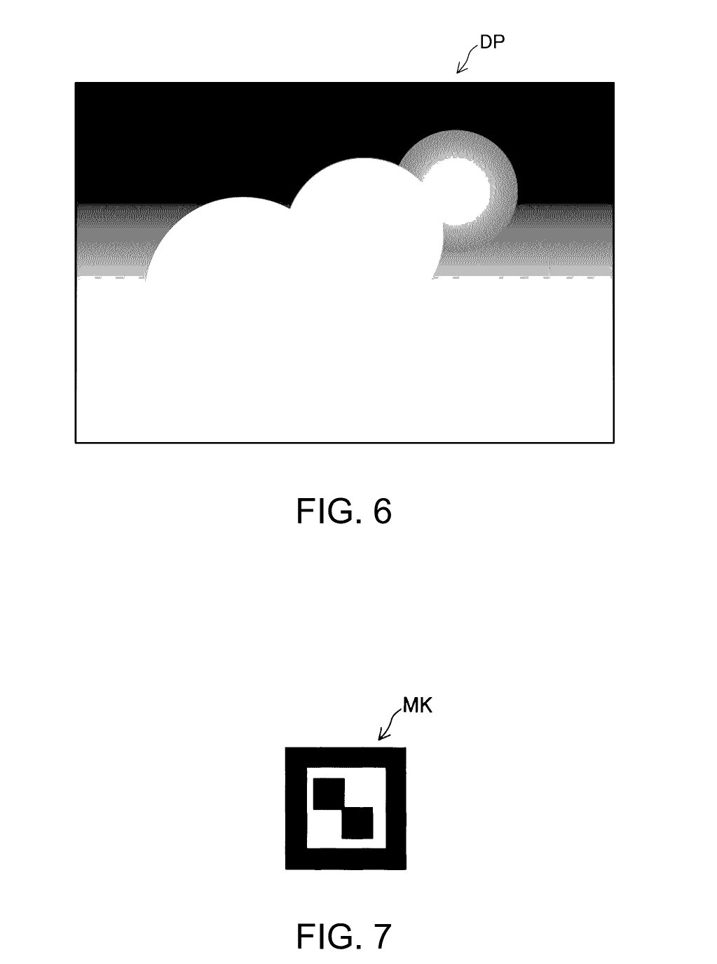

FIG. 6 is an explanatory diagram showing an example of the depth map. As shown in the figure, a depth map DP is a grayscale image and represents depth (a distance) in the pixels with light and shade.

After the execution of step S120 in FIG. 5, the CPU 140 recognizes a marker from the RGB image acquired in step S110 and acquires a two-dimensional position coordinate of the marker (step S130). In this embodiment, as shown in FIG. 4, the marker MK is stuck to the first ball B1, which is a target object on which the gripping work by a hand is performed, in advance. The CPU 140 recognizes the marker MK from the RGB image to enable recognition of the target object.

FIG. 7 is an explanatory diagram showing an example of the marker MK. As shown in the figure, the marker MK is a two-dimensional marker. An image of a pattern decided in advance functioning as an indicator for designating the target object is printed on the marker MK. The target object can be identified by the image of the pattern. In step S130 in FIG. 5, the CPU 140 recognizes the marker MK from the RGB image and acquires, as a two-dimensional position coordinate, a coordinate value indicating the position of the marker MK in a two-dimensional space.

Note that, in this embodiment, the recognition of the target object is enabled by sticking the marker to the target object in advance. On the other hand, as a modification, it is also possible that objects other than the first ball B1, which is the target object, that is, the second and third balls B2 and B3 are formed in other shapes, which are not a sphere, a shape pattern of the first ball B1, which is the target object, is stored in advance, and the target object is recognized by pattern recognition in the RGB image. It is also possible that the first ball B1 is colored in a color different from colors of the second and third balls B2 and B3, the color of the first ball B1, which is the target object, is stored in advance, and the target object is recognized by color recognition in the RGB image.

After the execution of step S130 in FIG. 5, the CPU 140 recognizes the marker MK from the depth map acquired in step S120 and acquires depth Dmk of the marker MK (step S140). The depth Dmk of the marker MK is the distance from the HMD 100 to the marker MK in the depth direction. Processing in steps S120 and S140 is equivalent to the target-object-depth-information acquiring section 164 (FIG. 2). Note that, as in the case of the acquisition of the two-dimensional position coordinate, it is also possible that the shape pattern of the first ball B1, which is the target object, is stored in advance and the target object is recognized by pattern recognition in the depth map.

Subsequently, the CPU 140 performs visual field conversion for converting the two-dimensional position coordinate of the marker acquired in step S130 and the depth map acquired in step S120 into values represented by a coordinate system seen through the optical-image display sections 26 and 28 (step S150). The camera 61 and the depth sensor 62 are provided in positions different from the positions of the optical-image display sections 26 and 28. The two-dimensional position coordinate of the marker acquired in step S130 is represented by a two-dimensional coordinate system seen from the camera 61. The depth map acquired in step S130 is represented by a two-dimensional coordinate system seen from the depth sensor 62. Therefore, in step S150, the CPU 140 performs the visual field conversion for converting the two-dimensional coordinate and the depth map into values represented by a two-dimensional coordinate system seen through the optical-image display sections 26 and 28.

Note that the two-dimensional coordinate system is a coordinate system indicating a two-dimensional space seen through the optical-image display sections 26 and 28. The two-dimensional space is a space perpendicular to a Z axis in the depth direction. Two coordinate axes of the two-dimensional coordinate system are an X axis and a Y axis in FIG. 1.

After the execution of step S150 in FIG. 5, the CPU 140 determines whether a hand is included in the RGB image acquired in step S110 (step S160). In this embodiment, a shape pattern of a hand of a person is stored in advance. Recognition of the hand is performed by pattern recognition in the RGB image. Instead of this, it is also possible that a color (a skin color) of the hand of the person is stored in advance and the hand is recognized by color recognition in the RGB image. Alternatively, the hand may be recognized from both of the shape pattern of the hand and the skin color. In step S160, when the hand is recognized in the RGB image, the CPU 140 determines that the hand is included in the RGB image. When the hand is not recognized in the RGB image, the CPU 140 determines that the hand is not included in the RGB image.

For the recognition of the hand, instead of the method of recognizing the hand with the shape pattern or the color, a configuration may be adopted in which a marker for identifying the hand is stuck to the hand of the user and the marker is recognized.

When determining in step S160 that the hand is not included in the RGB image, the CPU 140 advances the processing to “return” and once ends the auxiliary-image display routine. On the other hand, when determining in step S160 that the hand is included in the RGB image, the CPU 140 advances the processing to step S170.

In step S170, the CPU 140 extracts a portion recognized as the hand in step S160 from the depth map acquired in step S120 and acquires depth Dha of the hand from the extracted data. The depth Dha of the hand is the distance from the HMD 100 to the hand in the depth direction. Note that the distance to the hand is a distance to a specific point in the hand. In this embodiment, the specific point is set as a fingertip closest to the marker MK in the depth direction among the five fingertips. Instead of this, the specific point may be a tip of a specific finger (e.g., the middle finger) or may be another position such as the center of gravity position of the hand. The processing in steps S120 and S170 is equivalent to the operation-body-depth-information acquiring section 166 (FIG. 2).

After the execution of step S170, the CPU 140 determines whether the depth Dha of the hand acquired in step S170 is larger than a value obtained by subtracting a first distance D1 from the depth Dmk of the marker MK acquired in step S140 (step S180).

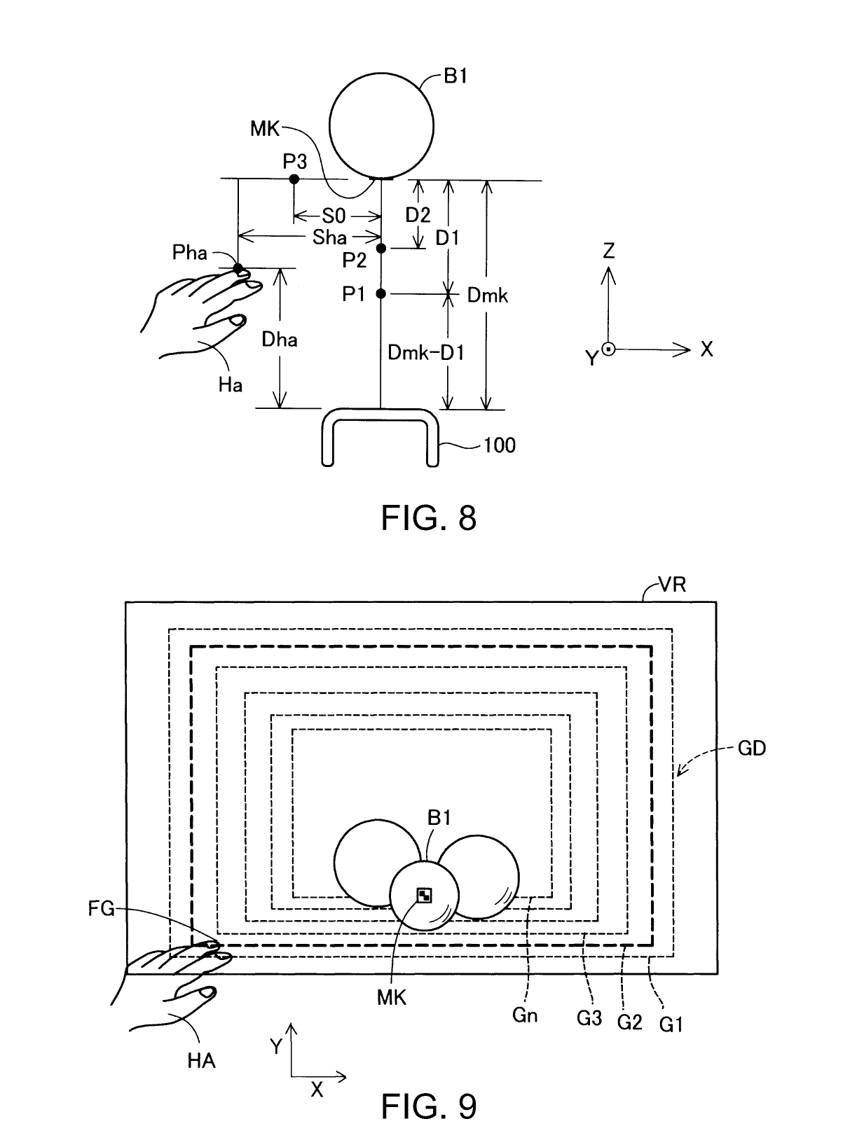

FIG. 8 is a plan view of the HMD 100 and the first ball B1 stuck with the marker MK viewed from above. A direction from the HMD 100 toward the marker MK is a depth direction Z. A position of the value obtained by subtracting the first distance D1 from the depth Dmk of the marker MK, that is, a position on the HMD 100 side by the first distance D1 with respect to the marker MK is a first position P1 in the figure. The depth Dha of the hand is a distance to a position Pha of a fingertip (the fingertip closest to the marker MK; the same applies below) of the hand in the depth direction Z. Therefore, the determination in step S180 means determining whether the position Pha of the fingertip of the hand has moved further to the marker MK side than the first position P1 in the depth direction.

When determining in step S180 that the depth Dha of the hand is equal to or smaller than the depth Dmk−D1 of the marker MK, that is, when determining that the position Pha of the fingertip of the hand has not moved further to the marker MK side than the first position P1, the CPU 140 advances the processing to “return” and once ends the auxiliary-image display routine.

On the other hand, when determining in step S180 that the depth Dha of the hand is larger than the depth Dmk−D1 of the marker MK, that is, when determining that the position Pha of the fingertip of the hand has moved further to the marker MK side than the first position P1, the CPU 140 advances the processing to step S190 and causes the display control section 162 (FIG. 2) to display an auxiliary image. The processing in steps S180 and S190 is equivalent to the auxiliary-image-display control section 168 (FIG. 2).

FIG. 9 is an explanatory diagram showing an example of the auxiliary image. In FIG. 9, the visual field VR of the user is illustrated. In the illustration, in the real space, the first ball B1 is visually recognized as the target object. An auxiliary image GD is displayed with respect to the ball B1. As shown in the figure, the auxiliary image GD is a line group (a grid) formed by lining up, at a fixed interval, rectangular broken lines G1, G2, G3, . . . , and Gn (n is a positive number) formed by collections of dots having the same depth such that the a depth feeling of the target object can be visually recognized. Note that, in the illustration, the number of rectangular broken lines is seven. However, the number of rectangular broken lines is not limited to seven and can be other numbers.

In FIG. 9, it is assumed that a second rectangular broken line G2 from the outer side indicates the depth Dmk−D1. In the figure, the rectangular broken line G2 is drawn as a thick line. However, this is only for convenience of explanation. The rectangular broken line G2 has line thickness same as the other rectangular broken lines G1 and G3 to Gn. When a fingertip FG of the hand HA has moved further to the first ball B1 side than the rectangular broken line G2, the affirmative determination is made in step S180 in FIG. 5. The auxiliary image GD is displayed in step S190. That is, the user cannot visually recognize the auxiliary image GD including the rectangular broken line G2 before the hand HA moves beyond the rectangular broken line G2. The auxiliary image GD including the rectangular broken line G2 is visually recognized only after the hand HA has moved beyond the rectangular broken line G2.

Referring back to FIG. 5, after the auxiliary image GD is displayed in step S190, the CPU 140 advances the processing to step S200 and sets a flag F, which indicates that the auxiliary image GD is displayed, to a value 1 (step S195). The flag F is a value 0 in an initial state and is set to the value 1 in step S195. After the execution of step S195, the CPU 140 advances the processing to “return” and once ends the auxiliary-image display routine.

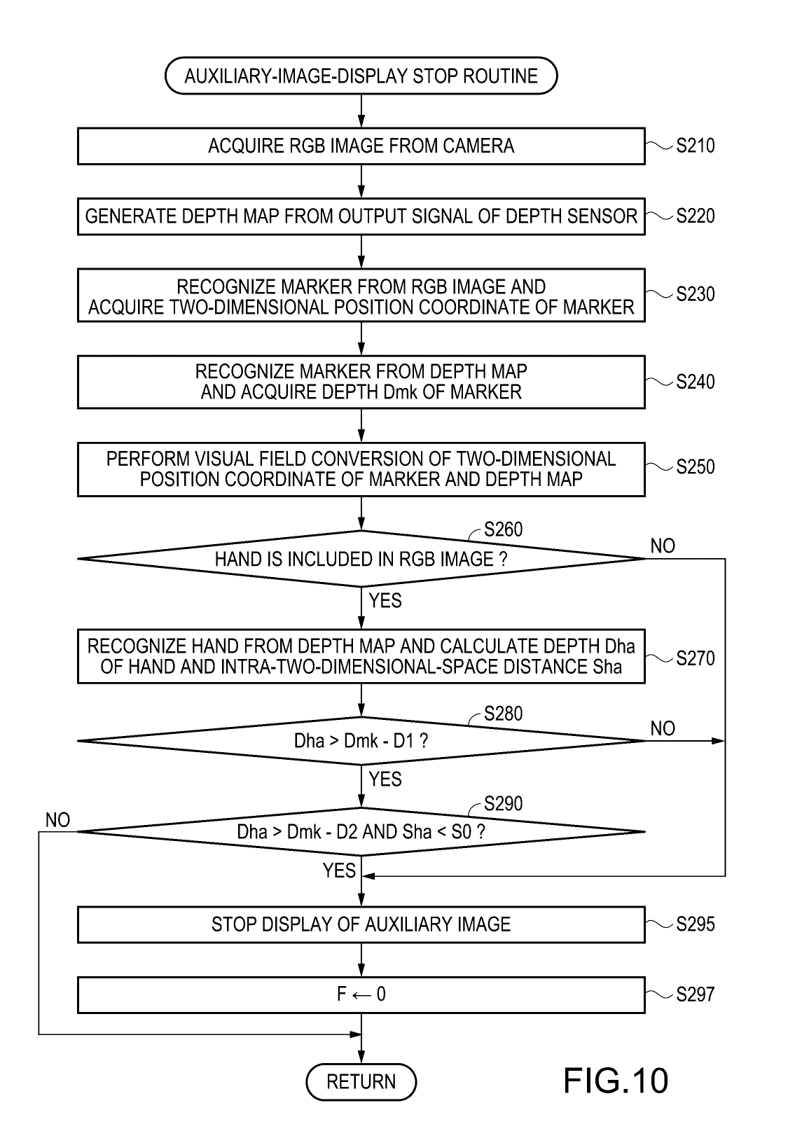

FIG. 10 is a flowchart for explaining an auxiliary-image-display stop routine. The auxiliary-image-display stop routine is executed instead of the auxiliary-image display routine in FIG. 5 when the flag F, which indicates that the auxiliary image GD is displayed, is the value 1. That is, when the flag F is the value 1, the auxiliary-image-display stop routine is repeatedly executed by the CPU 140 at every predetermined time.

Processing in steps S210 to S260 in the auxiliary-image-display stop routine is the same as the processing in steps S110 to S160 in the auxiliary-image display routine in FIG. 5.

When determining in step S260 that the hand is included in the RGB image, the CPU 140 advances the processing to step S270. In step S270, the CPU 140 extracts a portion recognized as the hand in step S260 from the depth map acquired in step S220 and calculates the depth Dha of the hand and an intra-two-dimensional-space distance Sha with respect to the marker MK of the hand from the extracted data. The depth Dha of the hand is the same as the depth Dha of the hand acquired in step S170 in the auxiliary-image display routine in FIG. 5. In step S270, the CPU 140 further calculates, using the depth map, a distance between the fingertip of the hand and the marker MK in the width direction of a two-dimensional space perpendicular to the depth direction (an X-Y space in FIG. 9) and acquires the distance as the intra-two-dimensional-space distance Sha.

Subsequently, as in step S180 in the auxiliary-image display routine in FIG. 5, the CPU 140 determines whether the depth Dha of the hand acquired in step S270 is larger than a value obtained by subtracting the first distance D1 from the depth Dmk of the marker MK acquired in step S240 (step S280). When determining that depth Dha of the hand is equal to or smaller than the depth Dmk−D1 of the marker MK, that is, when determining that the position Pha of the fingertip of the hand is not further on the marker MK side than the first position P1, the CPU 140 advances the processing to step S295, causes the display control section 162 (FIG. 2) to stop the display of the auxiliary image displayed in step S190 in FIG. 5, and clears the flag F, which indicates that the auxiliary image is displayed, to the value 0 (step S297). Note that, when determining in step S260 that the hand is not included in the RGB image, the CPU 140 also advances the processing to steps S295 and S297, stops the display of the auxiliary image, and clears the flag F to the value 0.

On the other hand, when determining in step S280 that the depth Dha of the hand is larger than the depth Dmk−D1 of the marker MK, that is, when determining that the position Pha of the fingertip of the hand has moved further to the marker MK side than the first position P1, the CPU 140 advances the processing to step S290. In step S290, the CPU 140 determines whether both of a first condition and a second condition explained below are satisfied.

The first condition is that the depth Dha of the hand acquired in step S270 is larger than a value obtained by subtracting a second distance D2 from the depth Dmk of the marker MK acquired in step S240. As shown in FIG. 8, the second distance D2 is shorter than the first distance D1. Therefore, the first condition means that the position Pha of the fingertip of the hand has moved further to the marker MK side than a second position P2 located further on the marker MK side than the first position P1.

The second condition is that the intra-two-dimensional-space distance Sha (see FIG. 8) acquired in step S270 is smaller than a predetermined value S0. That is, the second condition means that the distance between the position Pha of the fingertip of the hand and the marker MK in the X-Y space is a distance smaller than the predetermined value S0. In an example shown in FIG. 8, the position Pha of the fingertip of the hand and the marker MK are present in the same position in the Y-axis direction. In the example shown in FIG. 8, since Sha is larger than S0, the second condition is not satisfied.

When both of the first condition and the second condition are satisfied, this means that the fingertip of the hand has sufficiently approached the first ball B1, which is the target object, in the X-Y space in addition to the depth direction Z. Therefore, when determining in step S290 that both of the first condition and the second condition are satisfied, the CPU 140 advances the processing to steps S295 and S297, causes the display control section 162 to stop the display of the auxiliary image, and clears the flag F to the value 0. After the execution of step S297, the CPU 140 advances the processing to “return” and once ends the auxiliary-image-display stop routine.

On the other hand, when making the negative determination in step S290, that is, determining that at least one of the first condition and the second condition is not satisfied, the CPU 140 advances the processing to “return” and once ends the auxiliary-image-display stop routine. That is, when making the negative determination in step S290, the CPU 140 continues the display of the auxiliary image without stopping the display.

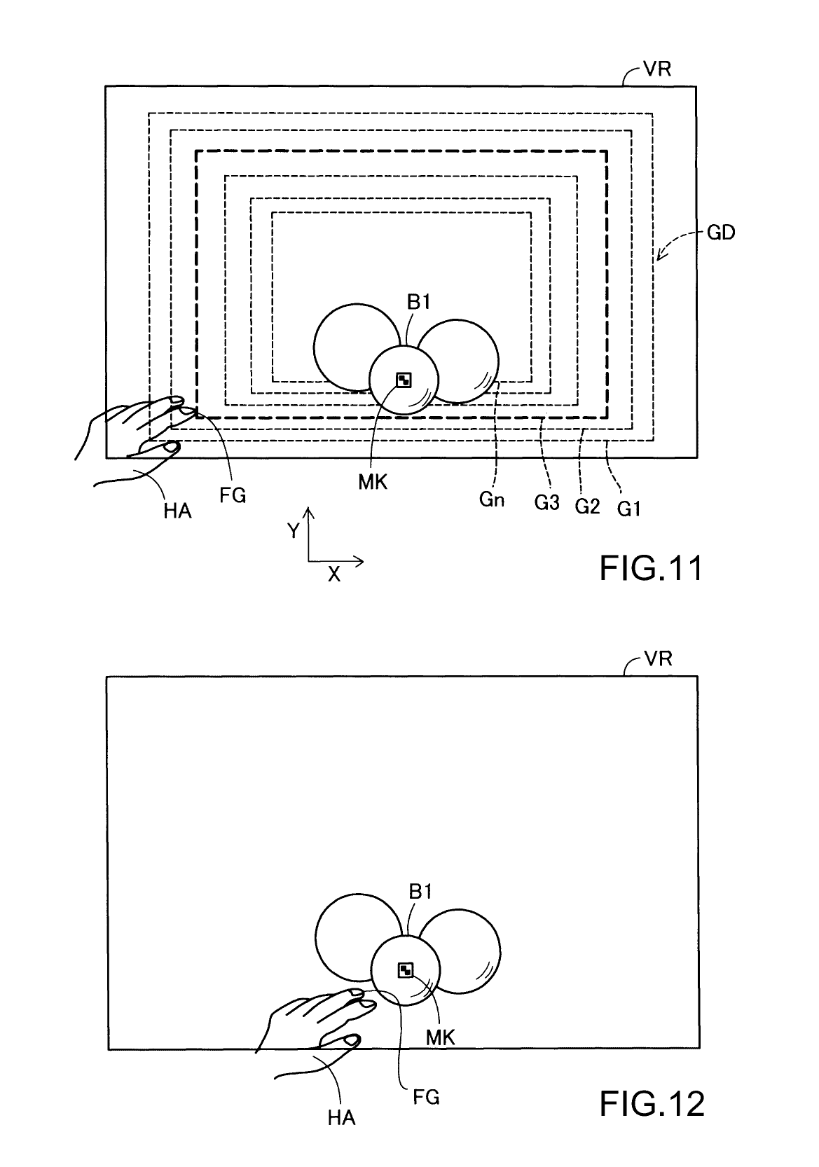

FIG. 11 is an explanatory diagram illustrating the visual field VR of the user immediately before the display of the auxiliary image is stopped. FIG. 12 is an explanatory diagram illustrating the visual field VR of the user immediately after the display of the auxiliary image is stopped. In FIG. 11, it is assumed that a third rectangular broken line G3 from the outer side indicates the depth Dmk-D2. In the figure, the rectangular broken line G3 is drawn as a thick line. However, this is only for convenience of explanation. The rectangular broken line G3 has line thickness same as the other rectangular broken lines G1, G2, and G4 to Gn. The auxiliary image GD is displayed until the fingertip FG of the hand HA reaches the rectangular broken line G3. Thereafter, when the fingertip FG of the hand HA has moved further to the first ball B1 side than the rectangular broken line G3 and the second condition is satisfied, as shown in FIG. 12, the display of the auxiliary image is stopped.

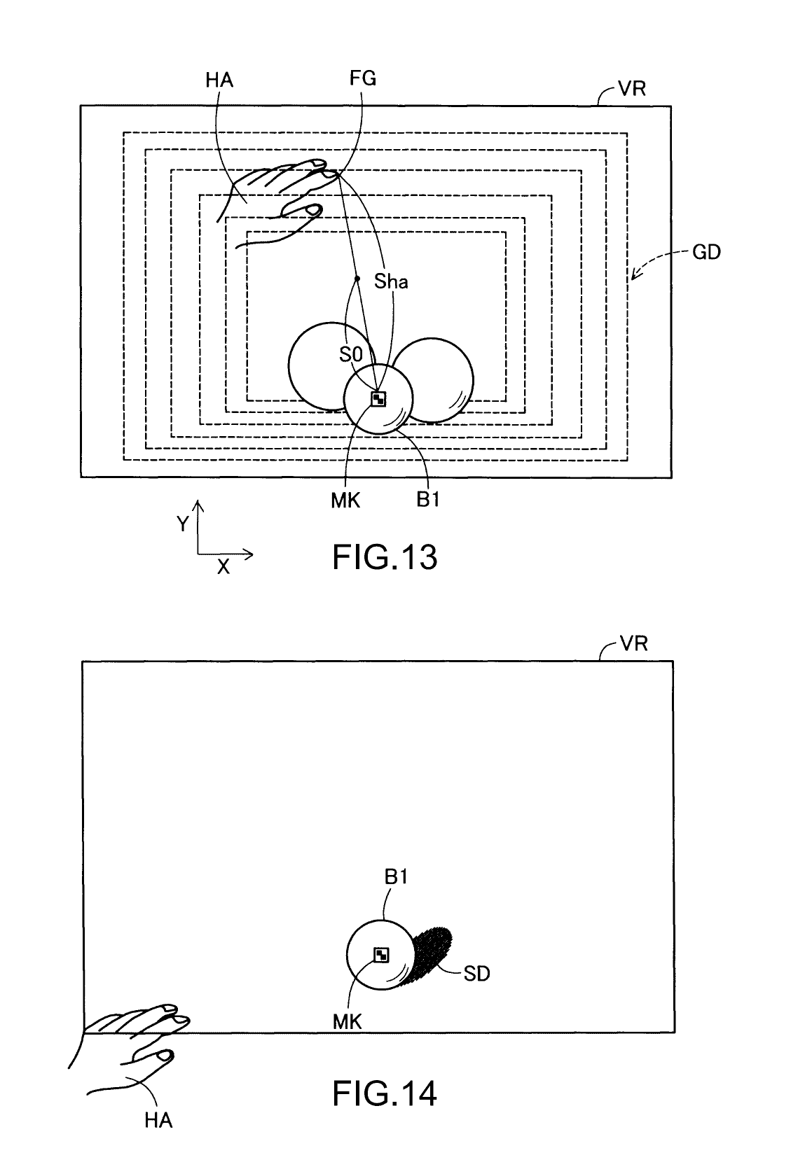

FIG. 13 is an explanatory diagram illustrating the visual field VR of the user in a state in which the display of the auxiliary image is not stopped. In this illustration, the intra-two-dimensional-space image Sha, which is the distance between the fingertip FG of the hand and the marker MK in the X-Y space, is larger than the predetermined value S0. Therefore, the display of the auxiliary image is not stopped. The auxiliary image GD is continuously displayed.

### D. Effects in the Embodiment

With the HMD 100 in this embodiment configured as explained above, when it is determined that the fingertip of the hand has moved further to the first ball B1 side than the rectangular broken line G2 in the depth direction Z from the HMD 100, the auxiliary image GD including the line group line formed by lining up, at the fixed interval, the rectangular broken lines G1 to Gn formed by the collections of the dots having the same depth is displayed on the optical-image display sections 26 and 28. Therefore, the user can easily grasp in which position the target object is present in the depth direction of the real space.

In this embodiment, when it is determined that the fingertip of the hand has moved further to the marker MK side than the second position P2 located further on the marker MK side than the first position P1 in the depth direction Z and further determined that the fingertip of the hand has approached the marker MK to a distance smaller than a predetermined value W0 on the X-Y plane, the display of the auxiliary image GD is stopped. Therefore, when it can be determined that the fingertip of the hand has sufficiently approached the marker MK in the depth direction Z and on the X-Y plane, the display of the auxiliary image GD is stopped. Accordingly, the display of the auxiliary image GD is erased immediately before work is performed on the first ball B1, which is the target object, by the fingertip of the finger. Therefore, the auxiliary image GD does not hinder the work. It is possible to prevent workability from being deteriorated.

### E. Modifications

Note that the invention is not limited to the embodiment and modifications of the embodiment and can be carried out in various modes without departing from the spirit of the invention. For example, modifications explained below are also possible.

### E-1. Modification 1

In the embodiment, the auxiliary image GD (FIG. 9) for facilitating the recognition of the position in the depth direction concerning the target object is the line group formed by lining up, at the fixed interval, the rectangular broken lines G1 to Gn formed by the collections of the dots having the same depth. On the other hand, as a modification, the auxiliary image may be a shadow of the target object.

FIG. 14 is an explanatory diagram showing a shadow SD functioning as the auxiliary image in a modification 1. The shadow SD is connected to the first ball B1, which is the target object. The shadow SD is a dark portion formed when a ray is prevented by the first ball B1. The length of the shadow SD indicates the depth of the first ball B1 with respect to the HMD. As the depth is larger (i.e., as the first ball B1 is farther from the HMD), the length of the shadow SD is larger. With this configuration, it is possible to achieve effects same as the effects in the embodiment.

Note that the auxiliary image does not need to be limited to the line group in the embodiment and the shadow in the modification. The auxiliary image can be changed to images having various shapes, colors, and the like such as a border line that indicates depth with a numerical value indicating a distance or with a color as long as the images are images for facilitating the recognition of the position in the depth direction concerning the target object.

### E-2. Modification 2

In the embodiment, the operation body operated by the user is the hand of the user. On the other hand, as a modification, the operation body may be a tool, a pointing rod, or the like.

### E-3. Modification 3

In the embodiment, the depth of the target object and the depth of the operation body are detected by the depth sensor. On the other hand, as a modification, the depth may be calculated on the basis of two images captured by a stereo camera or a monocular camera. Further, instead of the configuration for optically measuring depth, the distances from the target object and the operation body may be acquired using the technique of iBeacon (registered trademark) by providing BLE (Bluetooth Low Energy) terminals in the target object and the operation body. The distances may be measured using communication techniques other than iBeacon.

### E-4. Modification 4

In the embodiment, the configuration is adopted in which the auxiliary image is displayed when it is determined that the operation body has moved further to the target object side than the first position P1, which is the HMD side, by the first distance D1 with respect to the target object in the depth direction. On the other hand, as a modification, a configuration may be adopted in which the auxiliary image is displayed when it is determined that the operation body has moved to the target object side by a predetermined ratio of the distance between the HMD and the target object. In short, various conditions can be adopted as a predetermined condition satisfied by the positional relation between the target object and the operation body in the depth direction.

### E-5. Modification 5

In the embodiment, the configuration is adopted in which the object in the real world that can be visually recognized through the optical-image display sections 26 and (FIG. 1) is the target object and the auxiliary image functioning as AR is displayed with respect to the visually-recognized object in the real world. On the other hand, as a modification, a configuration may be adopted in which a 3D object functioning as AR is displayed on the optical-image display section as the target object and the auxiliary image is displayed with respect to the 3D object. The 3D object is an object disposed in a virtual three-dimensional space. Since a coordinate position on the three-dimensional space is decided, the target-object-depth-information acquiring section only has to be configured to acquire the target-object depth information from the coordinate position of the 3D object. With this configuration, when the operation body is brought close to the 3D object displayed on a screen, an auxiliary image for facilitating recognition of a position in the depth direction concerning the 3D object is displayed. The user can easily grasp in which position a virtual object is present in the depth direction.

Note that the coordinate position of the 3D object may be a position indicating the surface of the 3D object or may be a position indicating the center of the 3D object. Depth is calculated from these positions. Further, it is conceivable to add the 3D object further to the HMD side than the surface of the target object with respect to the target object in the outside world. However, in this case, the depth may be calculated assuming that the 3D object is the target object.

### E-6. Modification 6

In the embodiment, the HMD 100 is the transmission-type head mounted display through which an outside scene is transmitted in a state in which the user wears the HMD 100. On the other hand, as a modification, the HMD 100 may be configured as a non-transmission-type head mounted display that blocks transmission of an outside scene. This configuration can be implemented by, for example, capturing an outside scene with the camera, displaying the captured outside scene on the display section, and superimposing an AR image on an image of the outside scene. Note that the non-transmission-type head mounted display is suitable when the 3D object is displayed as the target object as explained in the modification 5.

### E-7. Other Modifications

In the embodiment, the configuration of the head mounted display is illustrated. However, the configuration of the head mounted display can be optionally decided in a range not departing from the spirit of the invention. For example, addition, deletion, conversion, and the like of the components can be performed.

The allocation of the components to the control section and the image display section in the embodiment is only an example. Various forms can be adopted. For example, forms explained below may be adopted.

(i) A form in which processing functions such as a CPU and a memory are mounted on the control section and only a display function is mounted on the image display section

(ii) A form in which processing functions such as CPUs and memories are mounted on both of the control section and the image display section

(iii) A form in which the control section and the image display section are integrated (e.g., a form in which the control section is included in the image display section to function as a wearable computer of an eyeglass type)

(iv) A form in which a smartphone or a portable game machine is used instead of the control section

(v) A form in which the connecting section (the cord) is removed by configuring the control section and the image display section to be capable of performing wireless communication and wireless power supply

In the embodiment, for convenience of explanation, the control section includes the transmitting section, and the image display section includes the receiving section. However, both of the transmitting section and the receiving section in the embodiment have a function capable of performing bidirectional communication and can function as a transmitting and receiving section. For example, the control section shown in FIG. 2 is connected to the image display section via a wired signal transmission line. However, the control section and the image display section may be connected via a wireless signal transmission line such as a wireless LAN, infrared communication, or Bluetooth (registered trademark).

For example, the configurations of the control section and the image display section explained in the embodiment can be optionally changed. Specifically, for example, a configuration may be adopted in which the touch pad is removed from the control section and the control section is operated only by the cross key. The control section may include another interface for operation such as a stick for operation. Devices such as a keyboard and a mouse may be connectable to the control section. The control section may receive inputs from the keyboard and the mouse. For example, the control section may acquire an operation input by a footswitch (a switch operated by a foot of the user) besides operation inputs by the touch pad and the cross key. For example, a visual-line detecting section such as an infrared sensor may be provided in the image display section to detect a visual line of the user and acquire an operation input by a command associated with a movement of the visual line. For example, a gesture of the user may be detected using a camera and an operation input by the command associated with the gesture may be acquired. In the gesture detection, a fingertip of the user, a ring worn on a hand of the user, a medical instrument held by the user, or the like can be used as a mark for the movement detection. If the operation input by the footswitch and the visual line can be acquired, even in work in which it is difficult for the user to release the hands, the input-information acquiring section can acquire the operation input from the user.

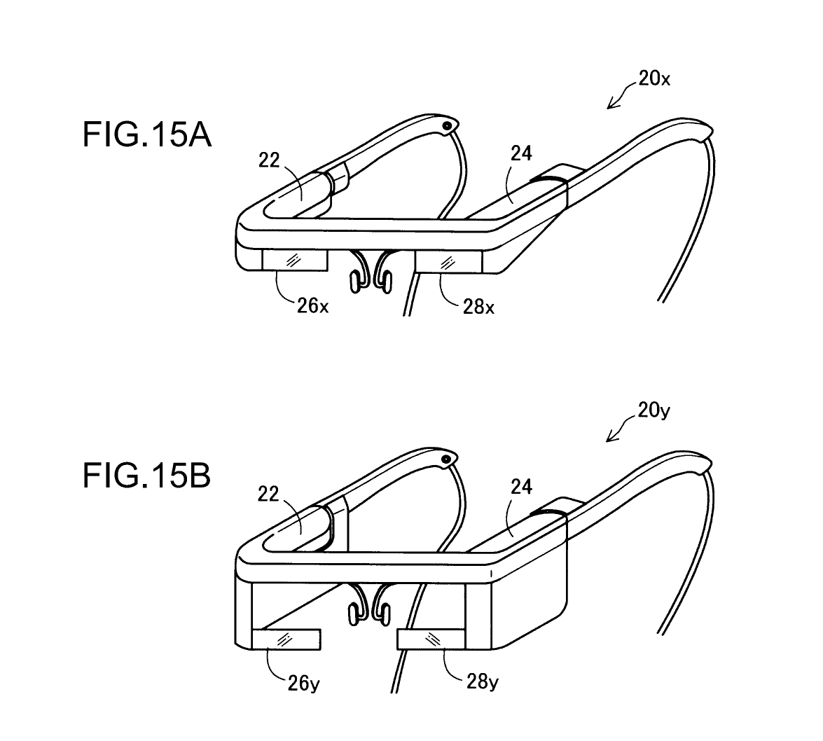

FIGS. 15A and 15B are explanatory diagrams showing the configurations of the exteriors of HMDs in modifications. In the case of an example shown in FIG. 15A, an image display section 20x includes a right optical-image display section 26x instead of the right optical-image display section 26 and includes a left optical-image display section 28x instead of the left optical-image display section 28. The right optical-image display section 26x and the left optical-image display section 28x are formed smaller than the optical members in the embodiment and are respectively disposed obliquely above the right and left eyes of the user when the user wears the HMD. In the case of an example shown in FIG. 15B, an image display section 20y includes a right optical-image display section 26y instead of the right optical-image display section 26 and includes a left optical-image display section 28y instead of the left optical-image display section 28. The right optical-image display section 26y and the left optical-image display section 28y are formed smaller than the optical members in the embodiment and are respectively disposed obliquely below the right and left eyes of the user when the user wears the HMD. In this way, the optical-image display sections only have to be disposed near the eyes of the user. The size of optical members forming the optical-image display sections is optional. The optical-image display sections can also be implemented an HMD in a form in which the optical-image display sections cover only a portion of the eyes of the user, in other words, a form in which the optical-image display sections do not completely cover the eyes of the user.

For example, in the embodiment, the head mounted display is the transmission-type head mounted display of a binocular type. However, the head mounted display may be a head mounted display of a monocular type.

For example, the functional sections such as the image processing section, the display control section, and the sound processing section are described as being implemented by the CPU developing, in the RAM, the computer program stored in the ROM or the hard disk. However, the functional sections may be configured using ASICs (Application Specific Integrated Circuits) designed to implement the functions of the functional sections.

For example, in the embodiment, the image display section is the head mounted display worn like eyeglasses. However, the image display section may be a normal flat display device (a liquid crystal display device, a plasma display device, an organic EL display device, etc.). In this case, as in the embodiment, the connection between the control section and the image display section may be the connection via the wired signal transmission line or the connection via the wireless signal transmission line. Consequently, the control section can also be used as a remote controller of the normal flat display device.

As the image display section, instead of the image display section worn like eyeglasses, an image display section of another form such as an image display section worn like a cap may be adopted. As the earphones, an ear hook type or a headband type may be adopted. The earphones may be omitted. For example, the image display section may be configured as a head-up display (HUD) mounted on vehicles such as an automobile and an airplane. For example, the image display section may be configured as a head mounted display incorporated in a body protector such as a helmet.

For example, in the embodiment, the display driving section is configured using the back light, the back-light control section, the LCD, the LCD control section, and the projection optical system. However, the form explained above is only an example. The display driving section may include components for implementing another system together with these components or instead of these components. For example, the display driving section may include an organic EL (Electro-Luminescence) display, an organic EL control section, and a projection optical system. For example, the display driving section can include a DMD (Digital Micro-mirror Device) or the like instead of the LCD. For example, the display driving section may be configured to include a signal-light modulating section including color light sources for generating color lights of RGB and a relay lens, a scanning optical system including a MEMS mirror, and a driving control circuit that drives the signal-light modulating section and the scanning optical system. Even if the organic EL, the DMD, or the MEMS mirror is used, “the emission region in the display driving section” is still the region to which image light is actually emitted from the display driving section. It is possible to obtain effect same as the effects in the embodiment by controlling the emission region in the devices (the display driving section) in the same manner as in the embodiment. For example, the display driving section may be configured to include one or more lasers that emit laser having intensity corresponding to a pixel signal to the retinas of the user. In this case, “the emission region in the display driving section” represents a region to which a laser beam representing an image is actually emitted from the display driving section. It is possible to obtain effects same as the effects in the embodiment by controlling the emission region of the laser beam in the laser (the display driving section) in the same manner as in the embodiment.

The invention is not limited to the embodiment, the examples, and the modifications explained above and can be implemented as various configurations without departing from the spirit of the invention. For example, the technical features in the embodiment, the examples, and the modifications corresponding to the technical features in the forms described in the summary can be replaced or combined as appropriate in order to solve a part or all of the problems or attain a part or all of the effects. Unless the technical features are explained in this specification as essential technical features, the technical features can be deleted as appropriate.

The entire disclosure of Japanese Patent Application No. 2015-190545, filed Sep. 29, 2015 is expressly incorporated by reference herein.

What is claimed is:

1. A head-mounted display device including a display section, the head-mounted display device comprising:
a target-object-depth-information acquiring section configured to acquire target-object depth information indicating depth from the head-mounted display device concerning a target object visually recognized via the display section;
an operation-body-depth-information acquiring section configured to acquire operation-body depth information indicating depth from the head-mounted display device concerning an operation body operated by a user in an outside world around the head-mounted display device; and
an auxiliary-image-display control section configured to cause, when determining on the basis of the acquired target-object depth information and the acquired operation-body depth information that a positional relation between the target object and the operation body satisfies a predetermined condition in a depth direction from the head-mounted display device, the display section to display an auxiliary image for facilitating recognition of a position in the depth direction concerning the target object.

2. The head-mounted display device according to claim 1, wherein the auxiliary-image-display control section causes the display section to display the auxiliary image when determining that the operation body has moved further to the target object side than a first position located on the head-mounted display device side by a first distance from the target object in the depth direction.

3. The head-mounted display device according to claim 2, further comprising a two-dimensional-position-information acquiring section configured to acquire two-dimensional-position information indicating a position of the target object and a position of the operation body in a two-dimensional space perpendicular to the depth direction wherein
the auxiliary-image-display control section stops the display of the auxiliary image when determining that the operation body has moved further to the target object side than a second position located on the head-mounted display device side by a second distance shorter than the first distance from the target object in the depth direction and determined that a distance between the operation body and the target object in the two-dimensional space is a distance smaller than a predetermined value on the basis of the acquired two-dimensional-position information.

4. The head-mounted display device according to claim 1, wherein the auxiliary image is a line group formed by lining up, at a fixed interval, rectangular broken lines formed by collections of dots having same depth.

5. The head-mounted display device according to claim 1, wherein
the display section is a display section through which the outside world can be visually recognized, and
the operation body is an object actually present in the outside world.

6. The head-mounted display device according to claim 1, wherein
the operation body is an object disposed in a virtual three-dimensional space, and
the target-object depth information is information indicating depth to the target object in the virtual three-dimensional space.

7. A control method for a head-mounted display device including a display section, the control method comprising:
acquiring target-object depth information indicating depth from the head-mounted display device concerning a target object visually recognized via the display section;
acquiring operation-body depth information indicating depth from the head-mounted display device concerning an operation body operated by a user in an outside world around the head-mounted display device; and
causing, when determining on the basis of the acquired target-object depth information and the acquired operation-body depth information that a positional relation between the target object and the operation body satisfies a predetermined condition in a depth direction from the head-mounted display device, the display section to display an auxiliary image for facilitating recognition of a position in the depth direction concerning the target object.

8. A computer program for controlling a head-mounted display device including a display section, the computer program causing a computer to implement:
a function for acquiring target-object depth information indicating depth from the head-mounted display device concerning a target object visually recognized via the display section;
a function for acquiring operation-body depth information indicating depth from the head-mounted display device concerning an operation body operated by a user in an outside world around the head-mounted display device; and
a function for causing, when determining on the basis of the acquired target-object depth information and the acquired operation-body depth information that a positional relation between the target object and the operation body satisfies a predetermined condition in a depth direction from the head-mounted display device, the display section to display an auxiliary image for facilitating recognition of a position in the depth direction concerning the target object.
